(19) United States
(12) Patent Application Publication
(10) Pub. No.: US 2026/0161967 A1
(43) Pub. Date: Jun. 11, 2026

(54) SECURE AND PRIVATE PROXY FINE TUNING

(71) Applicant: SAP SE, Walldorf (DE)

(72) Inventors: Jonas Boehler, Karlsruhe (DE); Benjamin Weggenmann, Karlsruhe (DE)

(21) Appl. No.: 18/975,583

(22) Filed: Dec. 10, 2024

(51) Int. Cl. G06N 5/04; G06N 20/20

(52) U.S. Cl. CPC G06N 5/04; G06N 20/20

(57) ABSTRACT

The present disclosure involves systems, software, and computer implemented methods for secure and private proxy fine tuning. One example method includes receiving an inference input for a first machine learning model. The input is provided to the first model, a second machine learning model that has an output structure that is consistent with a corresponding portion of the first model and a smaller overall size than the first model, and a tuned second machine learning model that is a tuned version of the second machine learning model. Output data is identified for the first model, the second model, and tuned second model. An output difference is determined based on the output data for the second model and the tuned second model. The output difference is applied to the output data for the first model to generate adapted output data that is used to generate a normalized output.

### TECHNICAL FIELD

The present disclosure relates to computer-implemented methods, software, and systems for secure and private proxy fine tuning.

### BACKGROUND

Secret sharing can enable multiple parties to split a secret value into multiple shares, one for each party, such that a certain minimum number of shares is required to reconstruct the secret value. Secret sharing can allow the parties to perform computations on the shares without revealing the secret value to the parties. Secret sharing can enable secure addition and secure multiplication, for example. By using secure addition and secure multiplication as building blocks, the parties can use those building blocks to securely perform any computation (e.g., secure comparison and other types of computations).

### SUMMARY

The present disclosure involves systems, software, and computer implemented methods for secure and private proxy fine tuning. An example method includes: receiving an inference input for a first machine learning model; providing the inference input to 1) the first machine learning model, 2) a second machine learning model that has an output structure or shape that is consistent with a corresponding portion of the first machine learning model and a smaller overall size than the first machine learning model, and 3) a tuned second machine learning model that is a tuned version of the second machine learning model that is tuned based on privacy-sensitive training data; identifying output data for the first machine learning model; identifying output data for the second machine learning model; identifying output data for the tuned second machine learning model; determining an output difference based on the output data for the second machine learning model and the output data for the tuned second machine learning model; applying the output difference to the output data for the first machine learning model to generate adapted output data for the first machine learning model; using the adapted output data for the first machine learning model to generate a normalized output; and providing the normalized output in response to the inference input.

Implementations may include one or more of the following features. The first machine learning model can be a large language model. At least some portions of the second machine learning model may be smaller than corresponding portions of the first machine learning model. The second machine learning model can have fewer elements than the first machine learning model. A portion of the second machine learning model that has the same structure as the corresponding portion of the first machine learning model can be a prediction layer. The privacy-sensitive training data can be provided by multiple parties. Secure computation can be used when training the tuned version of the second machine learning model using the privacy-sensitive training data provided by the multiple parties. The output data for the second machine learning model, the output data for the tuned second machine learning model, and the output data for the first machine learning model can be or include unnormalized probability values output by the second machine learning model, the tuned second machine learning model, or the first machine learning model, respectively, determined before an activation function is applied, that represent respective probabilities of an item belonging to a certain class. Using the adapted output data for the first machine learning model to generate the normalized output can include: providing the adapted output data for the first machine learning model to an activation function of the first machine learning model; and receiving the normalized output from the activation function of the first machine learning model. Applying the output difference can include adding the output difference to the output data for the first machine learning model.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for secure and private proxy fine tuning.

FIG. 2 illustrates an example system for secure and private proxy fine tuning.

FIG. 3A is a flowchart of an example method for secure and private proxy fine tuning.

FIG. 3B is a flowchart of an example method for inference use of a tuned proxy model.

### DETAILED DESCRIPTION

A software provider, such as an enterprise software provider, can have various products and systems that handle significant amounts of data from many different customers. The software provider can be party to certain agreements that allow the software provider to leverage customer data to improve products and service offerings of the software provider. However, despite these agreements, customers generally prefer or insist not having their data leak to other customers through training or use of the improved product and service offerings.

As an example, the software provider can identify an opportunity to adapt a machine learning model (e.g., a large language model) used by a product to specific tasks by fine-tuning the machine learning model with similar transactional data from many customers. However, the service provider and customers may be concerned that reconstruction or membership inference attacks could occur that could leak information about the training data from one customer to another customer when the trained model is queried.

Privacy-preserving fine-tuning approaches such as differential privacy (DP) and/or secure computation (SC) can mitigate a risk of such attacks. However, traditional use of DP and SC can make training of LLMs and other large models that are typically used in generative AI (Artificial Intelligence) applications even more resource-intensive. Traditional use of DP and SC in training large models in particular can incur a resource cost that is prohibitive. Further challenges can arise when the training data is split among multiple customers where each customer wants to keep their training data private.

An improved machine learning model tuning approach can be used that guarantees training confidentiality and inference anonymization without a same performance overhead inherent in directly using SC and DP. To mitigate performance overhead issues, the improved tuning approach can use a combination of privacy-preserving and/or secure training methods and proxy fine-tuning. Proxy fine-tuning can include adapting a larger model to specific tasks by securely and/or privately only fine-tuning a much smaller proxy model. The solution allows application of SC and/or DP training to the smaller model, thus substantially improving tuning performance overhead issues.

In further detail, the solution can result in a substantial reduction in memory requirements for loading and tuning the smaller model instead of the larger model, thus enabling tuning with fewer resources (e.g., fewer number of required processors and less required memory capacity). Resource savings can be particularly amplified when privacy-preserving approaches such as SC and DP are taken into account, since complex and costly encryption operations are substantially reduced by tuning the smaller proxy model rather than the larger model. Fine tuning the proxy model can thus result in substantial reductions in performance overhead, thereby enabling adaptation/tuning of larger models to new tasks in a private and secure manner for models for which tuning would otherwise be impractically slow, prohibitively costly, or otherwise infeasible.

Machine learning models, therefore, including larger models, can be efficiently tuned for specific tasks while leveraging private data. Finetuning larger models on specific, private data can result in improved accuracy of generic models, as compared to use of untuned versions of those models. The solution can provide various benefits to enterprise customers of an enterprise software or services provider. For example, the solution can provide improved forecasting based on sensitive internal transactional and inventory data. As other examples, the solution can improve summarization of customer-related reports with internal context or sensitive information, such as, financial reports or human resources reports. Additionally, recommendation systems can be enhanced by leveraging internal product data, such as user reviews, feedback, and usage patterns. The solution can be used in any given context in which tuning a large model to specific tasks, using private data, is desired.

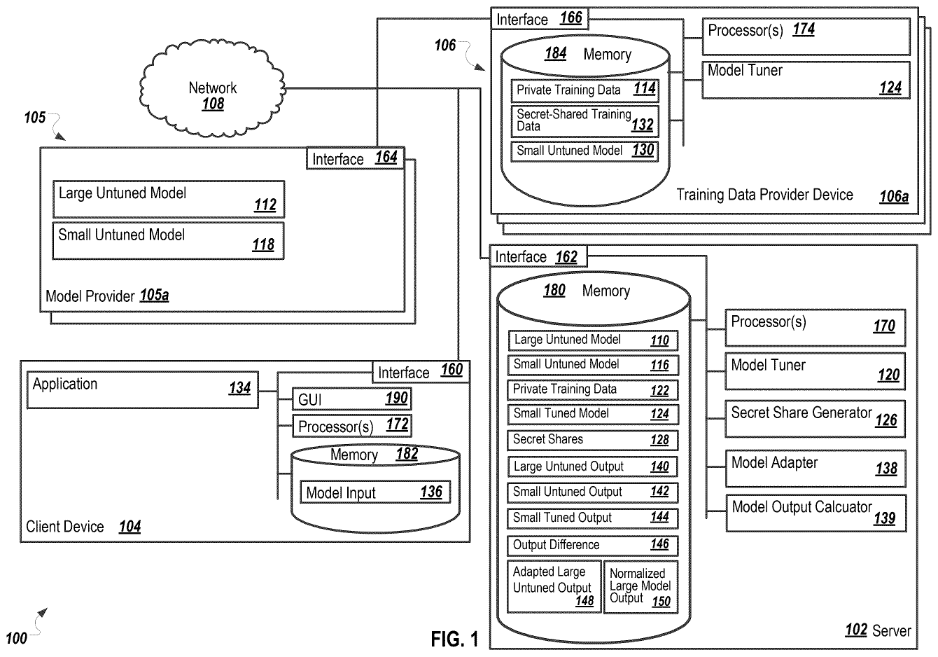

FIG. 1 is a block diagram illustrating an example system 100 for secure and private proxy fine tuning. Specifically, the illustrated system 100 includes or is communicably coupled with a server 102, a client device 104, model providers 105, training data provider devices 106, and a network 108. Although shown separately, in some implementations, functionality of two or more systems or servers may be provided by a single system or server. In some implementations, the functionality of one illustrated system, server, or component may be provided by multiple systems, servers, or components, respectively.

An entity may have or have access to a machine learning model that the entity desires to tune for a specific task. The machine learning model can be referred to as a large untuned model, and can be a large language model or another type of machine learning model such as a computer vision model or some other type of classifier. The large untuned model may be untuned with respect to a specific task, for example, while possibly being pre-trained one or more generic tasks. The entity may have the large untuned model, as illustrated by a large untuned model 110 in the server 102, or the entity may acquire or obtain access to the large untuned model, as illustrated by a large untuned model 112 in a model provider 105a.

The entity may desire to tune the large untuned model 110 using privacy-sensitive training data, such as private training data 114 owned by another entity shown in a training data provider device 106a. In examples in which multiple parties have training data, each training data provider device 106 of a respective training data entity can have a set of private training data 114.

While the entity can apply privacy-enhancing techniques (PETs)—such as differential privacy mechanisms and secure computation protocols—when performing tuning using set(s) of private training data 114, applying PETs when tuning the large untuned model 110 may be prohibitively expensive and infeasible, as noted above. Rather than tune the large untuned model 110, the entity can tune a small untuned model 116, which may be a model available to the entity or a copy of or a reference to a small untuned model 118 available from the model provider 105a (or another model provider 105).

The small untuned model 116 can be smaller with respect to smaller and/or fewer elements or layers, as compared to the large untuned model 110. While smaller than the large untuned model 110, the small untuned model 116 can have a common or matching portion, element, or layer as the large untuned model 110, such as a same or similar prediction or output layer. Thus, the small untuned model 116 and the large untuned model 110 can have a same output space. In some cases, the same/similar layer common to both the small untuned model 116 and the large untuned model 110 is a SoftMax layer that predicts a text token.

In some examples, a model tuner 120 can tune the small untuned model 116, using private training data 122 (which can include copies of one or more sets of private training data 114) to generate a small tuned model 124. The server 102 can be considered as trusted by training data providers, for example. The model tuner 120 can tune the small untuned model 116 using the private training data 122 using DP techniques. In other examples that use multiple sets of private training data 114 to generate the small tuned model 124, secure computation can be performed. For example, a secret share generator 126 can generate secret shares 128 of the private training data 122 and the model tuner 120 can perform tuning using the secret shares 128.

In some cases, the entity can outsource tuning of the small untuned model 116 to one or more other parties. For instance, a training data provider or another entity that is separate from the entity and the training data provider entities can perform the tuning. In one example and as illustrated in FIG. 1, the training data provider device 106a of a training data provider entity includes a copy 130 of the small untuned model 116 (or a reference to the small untuned model 116) and secret-shared training data 132, which can be used by the training data provider entity to tune the small untuned model. In examples where an external entity separate from the entity and separate from the training data provider entities provides outsourced model tuning, the training data provider entities can secret share respective training data sets to the external entity, which can perform the tuning using secret-shared joint data.

After the small tuned model 124 has been generated, differences in outputs from the small tuned model 124 and the small untuned model 116 can be used to adapt the large untuned model 110 during an inference phase. For example, a user of an application 134 on the client device 104 can provide a model input 136 and trigger a request to use the large untuned model 110 using the model input 136. Although a user/client request is illustrated, a model use request can be invoked via a server to server message or from other backend processing. The model input 136 can be provided as input by a model adapter 138 to each of the large untuned model 110, the small untuned model 116, and the small tuned model 124. A model output calculator 139 can determine output data (e.g., logit data, probability data, or some other kind of model output) for the large untuned model 110 (e.g., large untuned output 140), the small untuned model 116 (e.g., small untuned output 142), and the small tuned model 124 (e.g., small tuned output 144). In some cases, respective output data for a respective model can represent unnormalized probability values output by a certain layer of the model that are determined before an activation function is applied that represent respective probabilities of an item belonging to a certain class. Output data of a model may be fed into an activation function (e.g., a SoftMax activation function) to obtain normalized probability scores over an output domain, such as a set of possible tokens in a language model. To enable calculation of output differences, the large untuned output 140, the small untuned output 142, and the small tuned output 144 have matching shapes/dimensions.

The model adapter 138 (or another component of the server 102) can determine an output difference 146 between the small tuned output 144 and the small untuned output 142 (e.g., based on various types of possible operations for determining the difference, such as addition, subtraction, multiplication, or a combination of these). The output difference 146 can represent a difference in model activations between the small tuned model 124 and the small untuned model 116 that occurred as a result of the generation of the small tuned model 124 from tuning using the private training data 122.

The model adapter 138 can adapt the large untuned model 110 during the inference phase by applying (e.g., by using addition or some other operation) the output difference 146 to the large untuned output 140 to generate an adapted large untuned output 148. The model output calculator 139 can generate a normalized large model output 150 based on the adapted large untuned output 148 (e.g., by providing the adapted large untuned output 148 to an activation function of the large untuned model 110). The normalized large model output 150 can be provided to a requester (e.g., the client device 104) in response to the request received from the requester.

As used in the present disclosure, the term “computer” is intended to encompass any suitable processing device. For example, although FIG. 1 illustrates a single server 102, and a single client device 104, the system 100 can be implemented using a single, stand-alone computing device, two or more servers 102, or two or more client devices 104. Indeed, the server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 160, 162, 164, and 166 are used by the client device 104, the server 102, the model providers 105, and the training data provider devices 106, respectively, for communicating with other systems in a distributed environment—including within the system 100—connected to the network 108. Generally, the interfaces 160, 162, 164, and 166 each comprise logic encoded in software and/or hardware in a suitable combination and operable to communicate with the network 108. More specifically, the interfaces 160, 162, 164, and 166 may each comprise software supporting one or more communication protocols associated with communications such that the network 108 or interface's hardware is operable to communicate physical signals within and outside of the illustrated system 100.

The server 102, the client device 104, and the training data provider devices 106 each respectively includes one or more processors 170, 172, or 174. Each processor in the processors 170, 172, or 174 may be a central processing unit (CPU), a blade, an application specific integrated circuit (ASIC), a field-programmable gate array (FPGA), or another suitable component. Generally, each processor in the processors 170, 172, or 174 executes instructions and manipulates data to perform the operations of the respective device.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Python, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102, the client device 104, and the training data provider devices 106 each respectively includes memory 180, 182, or 184. In some implementations, a device can include multiple memories. Each of the memories 180, 182, and 184 may include any type of memory or database module and may take the form of volatile and/or non-volatile memory including, without limitation, magnetic media, optical media, random access memory (RAM), read-only memory (ROM), removable media, or any other suitable local or remote memory component. Each of the memories 180, 182, and 184 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the system 100.

The client device 104 may generally be any computing device operable to connect to or communicate with the server 102 via the network 108 using a wireline or wireless connection. In general, the client device 104 comprises an electronic computer device operable to receive, transmit, process, and store any appropriate data associated with the system 100 of FIG. 1. The client device 104 can include one or more client applications, including the application 134. A client application is any type of application that allows the client device 104 to request and view content on the client device 104. In some implementations, a client application can use parameters, metadata, and other information received at launch to access a particular set of data from the server 102. In some instances, a client application may be an agent or client-side version of the one or more enterprise applications running on an enterprise server (not shown).

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or a GUI 190.

The GUI 190 of the client device 104 interfaces with at least a portion of the system 100 for any suitable purpose, including generating a visual representation of the application 134. In particular, the GUI 190 may be used to view and navigate various Web pages, or other user interfaces. Generally, the GUI 190 provides the user with an efficient and user-friendly presentation of business data provided by or communicated within the system. The GUI 190 may comprise a plurality of customizable frames or views having interactive fields, pull-down lists, and buttons operated by the user. The GUI 190 contemplates any suitable graphical user interface, such as a combination of a generic web browser, intelligent engine, and command line interface (CLI) that processes information and efficiently presents the results to the user visually.

There may be any number of client devices 104 associated with, or external to, the system 100. For example, while the illustrated system 100 includes one client device 104, alternative implementations of the system 100 may include multiple client devices 104 communicably coupled to the server 102 and/or the network 108, or any other number suitable to the purposes of the system 100. Additionally, there may also be one or more additional client devices 104 external to the illustrated portion of system 100 that are capable of interacting with the system 100 via the network 108. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

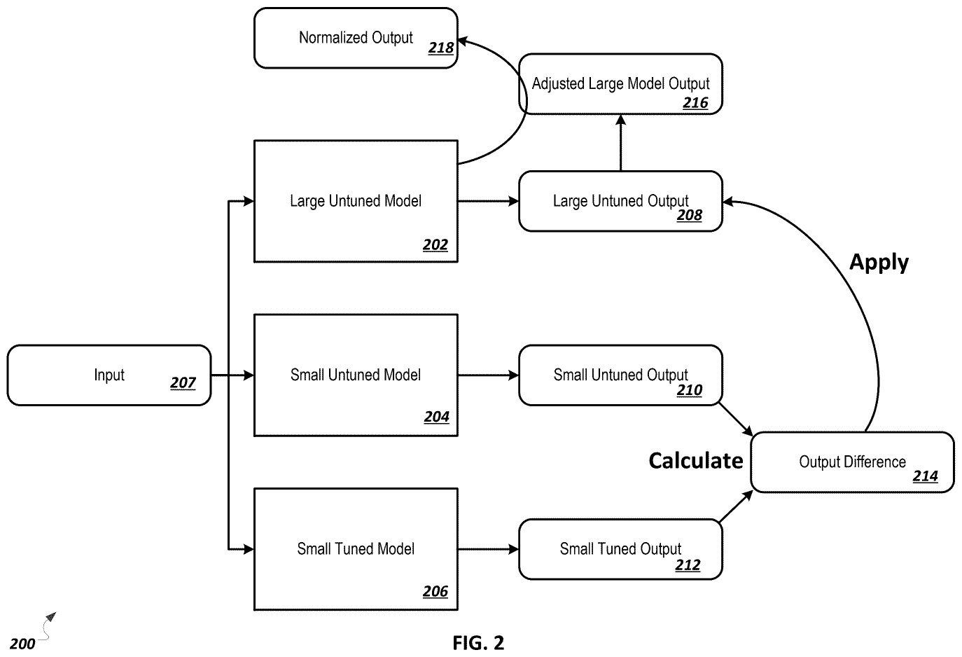

FIG. 2 illustrates an example system 200 for secure and private proxy fine tuning. An entity desiring tuning of a large untuned model 202 for a specific task can identify the large untuned model 202. The entity can also identify a small untuned model 204 that while sharing a common portion (e.g., prediction layer) with the large untuned model 202 is overall smaller in size and complexity than the large untuned model 202.

Rather than tune the large untuned model 202 which might require a prohibitive amount of resources, especially if/when PET approaches are required due to privacy-sensitive training data used for tuning, the entity can instead generate a small tuned model 206 by tuning the small untuned model 204. If training data is private, PET approaches can be used when generating the small tuned model 206.

During an inference phase for an input 207, large untuned output data 208, small untuned output data 210, and small tuned output data 212 can be generated for the large untuned model 202, the small untuned model 204, and the small tuned model 206, respectively. An output difference 214 can be calculated that reflects a difference between the small untuned output data 210 and the small tuned output data 212.

The output difference 214 can be applied (e.g., added) to the large untuned output data 208 to generate adjusted large model output data 216. The adjusted large model output data 216 can be provided to, for example, an activation function of the large untuned model 202, to generate a normalized output 218. The normalized output 218 can represent an output of the large untuned model 202 that is generated after a corresponding amount of model weight adjustments are applied to the large untuned model 202 as occurred during generation of the small tuned model 206 from the small untuned model 204.

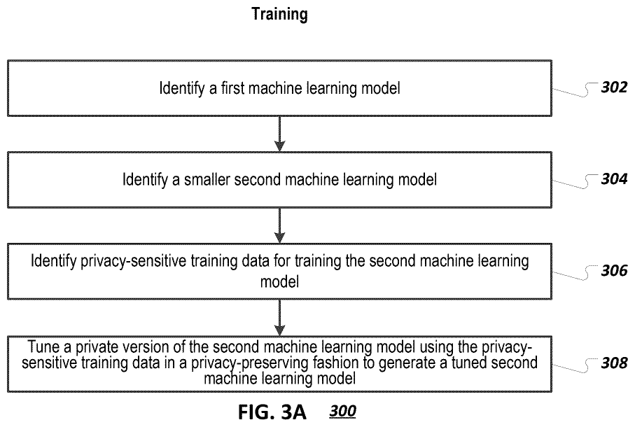

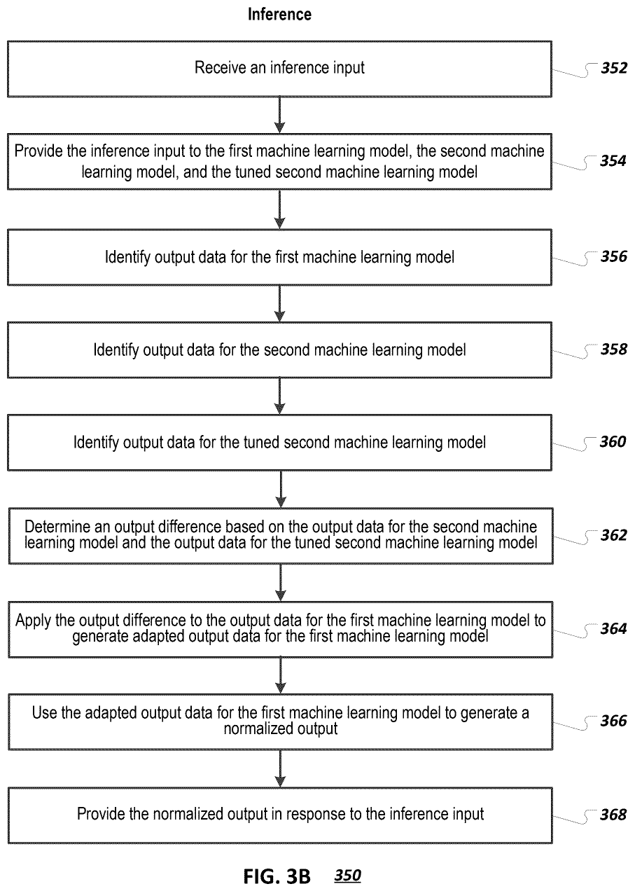

FIG. 3A is a flowchart of an example method 300 for secure and private proxy fine tuning. It will be understood that method 300 and related methods may be performed, for example, by any suitable system, environment, software, and hardware, or a combination of systems, environments, software, and hardware, as appropriate. For example, one or more of a client, a server, or other computing device can be used to execute method 300 and related methods and obtain any data from the memory of a client, the server, or the other computing device. In some implementations, the method 300 and related methods are executed by one or more components of the system 100 described above with respect to FIG. 1. For example, the method 300 and related methods can be executed by the server 102 of FIG. 1.

At 302, a first machine learning model is identified. The first machine learning model can be a large language model or some other type of model.

At 304, a second machine learning model is identified. A portion of the second machine learning model has a same structure as a corresponding portion of the first machine learning model and an overall size of the second machine learning model is smaller than the first machine learning model (thus the second machine learning model can be referred to as a smaller machine learning model). In some examples, at least some portions of the second machine learning model are smaller than corresponding portions of the first machine learning model. In some examples, the second machine learning model has fewer elements than the first machine learning model. In some examples, the portion of the second machine learning model that has the same structure as the corresponding portion of the first machine learning model is a predication layer.

At 306, privacy-sensitive training data for training the second machine learning model is identified. In some implementations, the privacy-sensitive training data is provided by multiple parties.

At 308, a private version of the second machine learning model is tuned using the privacy-sensitive training data in a privacy-preserving fashion to generate a tuned second machine learning model. Secure computation can be used when training the private version of the second machine learning model using privacy-sensitive training data provided by the multiple parties.

FIG. 3B is a flowchart of an example method 350 for inference use of a tuned proxy model. It will be understood that method 350 and related methods may be performed, for example, by any suitable system, environment, software, and hardware, or a combination of systems, environments, software, and hardware, as appropriate. For example, one or more of a client, a server, or other computing device can be used to execute method 350 and related methods and obtain any data from the memory of a client, the server, or the other computing device. In some implementations, the method 350 and related methods are executed by one or more components of the system 100 described above with respect to FIG. 1. For example, the method 350 and related methods can be executed by the server 102 of FIG. 1.

At 352, an inference input is received for a first machine learning model.

At 354, the inference input is provided to 1) the first machine learning model, 2) a second machine learning model that has an output structure or shape consistent with a corresponding portion of the first machine learning model and a smaller overall size than the first machine learning model, and 3) a tuned second machine learning model that is a tuned version of the second machine learning model that is tuned based on privacy-sensitive training data.

At 356, output data for the first machine learning model is identified.

At 358, output data for the second machine learning model is identified.

At 360, output data for the tuned second machine learning model is identified. The output data for the second machine learning model, the output data for the tuned second machine learning model, and the output data for the first machine learning model can be or represent unnormalized probability values output by the second machine learning model, the tuned second machine learning model, or the first machine learning model, respectively, determined before an activation function is applied, that represent respective probabilities of an item belonging to a certain class.

At 362, an output difference is determined based on the output data for the second machine learning model and the output data for the tuned second machine learning model.

At 364, the output difference is applied to the output data for the first machine learning model to generate adapted output data for the first machine learning model. For example, the output difference can be added to the output data for the first machine learning model.

At 366, the adapted output data for the first machine learning model is used to generate a normalized output. For example, the adapted output data can be provided to an activation function of the first machine learning model.

At 368, the normalized output is provided in response to the inference input.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving an inference input for a first machine learning model;
providing the inference input to 1) the first machine learning model, 2) a second machine learning model that has a same output structure or shape consistent with a corresponding portion of the first machine learning model and a smaller overall size than the first machine learning model, and 3) a tuned second machine learning model that is a tuned version of the second machine learning model that is tuned based on privacy-sensitive training data;
identifying output data for the first machine learning model;
identifying output data for the second machine learning model;
identifying output data for the tuned second machine learning model;
determining an output difference based on the output data for the second machine learning model and the output data for the tuned second machine learning model;
applying the output difference to the output data for the first machine learning model to generate adapted output data for the first machine learning model;
using the adapted output data for the first machine learning model to generate a normalized output; and
providing the normalized output in response to the inference input.

2. The computer-implemented method of claim 1, wherein the first machine learning model is a large language model.

3. The computer-implemented method of claim 1, wherein at least some portions of the second machine learning model are smaller than corresponding portions of the first machine learning model.

4. The computer-implemented method of claim 1, wherein the second machine learning model has fewer elements than the first machine learning model.

5. The computer-implemented method of claim 1, wherein a portion of the second machine learning model that has a same structure as the corresponding portion of the first machine learning model is a prediction layer.

6. The computer-implemented method of claim 1, wherein the privacy-sensitive training data is provided by multiple parties.

7. The computer-implemented method of claim 6, further comprising using secure computation when training the tuned version of the second machine learning model using the privacy-sensitive training data provided by the multiple parties.

8. The computer-implemented method of claim 1, wherein the output data for the second machine learning model, the output data for the tuned second machine learning model, and the output data for the first machine learning model comprise unnormalized probability values output by the second machine learning model, the tuned second machine learning model, or the first machine learning model, respectively, determined before an activation function is applied, that represent respective probabilities of an item belonging to a certain class.

9. The computer-implemented method of claim 8, wherein using the adapted output data for the first machine learning model to generate the normalized output comprises:
providing the adapted output data for the first machine learning model to an activation function of the first machine learning model; and
receiving the normalized output from the activation function of the first machine learning model.

10. The computer-implemented method of claim 1, wherein applying the output difference comprises adding the output difference to the output data for the first machine learning model.

11. A system, comprising:
a computing device; and
a computer-readable storage device coupled to the computing device and having instructions stored thereon which, when executed by the computing device, cause the computing device to perform operations comprising:
receiving an inference input for a first machine learning model;
providing the inference input to 1) the first machine learning model, 2) a second machine learning model that has an output structure or shape that is consistent with a corresponding portion of the first machine learning model and a smaller overall size than the first machine learning model, and 3) a tuned second machine learning model that is a tuned version of the second machine learning model that is tuned based on privacy-sensitive training data;
identifying output data for the first machine learning model;
identifying output data for the second machine learning model;
identifying output data for the tuned second machine learning model;
determining an output difference based on the output data for the second machine learning model and the output data for the tuned second machine learning model;
applying the output difference to the output data for the first machine learning model to generate adapted output data for the first machine learning model;
using the adapted output data for the first machine learning model to generate a normalized output; and
providing the normalized output in response to the inference input.

12. The system of claim 11, wherein the first machine learning model is a large language model.

13. The system of claim 11, wherein at least some portions of the second machine learning model are smaller than corresponding portions of the first machine learning model.

14. The system of claim 11, wherein the second machine learning model has fewer elements than the first machine learning model.

15. The system of claim 11, wherein a portion of the second machine learning model that has a same structure as the corresponding portion of the first machine learning model is a prediction layer.

16. A non-transitory computer-readable storage medium coupled to one or more processors and having instructions stored thereon which, when executed by the one or more processors, cause the one or more processors to perform operations comprising:
receiving an inference input for a first machine learning model;
providing the inference input to 1) the first machine learning model, 2) a second machine learning model that has an output structure or shape that is consistent with a corresponding portion of the first machine learning model and a smaller overall size than the first machine learning model, and 3) a tuned second machine learning model that is a tuned version of the second machine learning model that is tuned based on privacy-sensitive training data;
identifying output data for the first machine learning model;
identifying output data for the second machine learning model;
identifying output data for the tuned second machine learning model;
determining an output difference based on the output data for the second machine learning model and the output data for the tuned second machine learning model;
applying the output difference to the output data for the first machine learning model to generate adapted output data for the first machine learning model;
using the adapted output data for the first machine learning model to generate a normalized output; and
providing the normalized output in response to the inference input.

17. The computer-readable storage medium of claim 16, wherein the first machine learning model is a large language model.

18. The computer-readable storage medium of claim 16, wherein at least some portions of the second machine learning model are smaller than corresponding portions of the first machine learning model.

19. The computer-readable storage medium of claim 16, wherein the second machine learning model has fewer elements than the first machine learning model.

20. The computer-readable storage medium of claim 16, wherein a portion of the second machine learning model that has a same structure as the corresponding portion of the first machine learning model is a prediction layer.
